(19) United States
(12) Patent Application Publication
(10) Pub. No.: US 2018/0162426 A1
(43) Pub. Date: Jun. 14, 2018

(54) RAILWAY VEHICLE INCLUDING A HEAD-UP DISPLAY

(71) Applicant: ALSTOM Transport Technologies, Saint-ouen (FR)

(72) Inventors: Denis Miglianico, Paris (FR); Luc Moyart, La Madeleine (FR); François Houbre, Le Tignet (FR); Patrice Nagtegaele, Mouans Sartoux (FR); Jonathan Blanche, Antibes (FR)

(21) Appl. No.: 15/836,745

(22) Filed: Dec. 8, 2017

(30) Foreign Application Priority Data
Dec. 8, 2016 (FR) 1662170

(51) Int. Cl. B61L 15/00; G02B 27/01

(52) U.S. Cl. CPC B61L 15/009; G02B 27/0149; G02B 2027/0159; G02B 2027/0163; G02B 2027/0156

(57) ABSTRACT

A railway vehicle includes a driving cab that has a head-up display. The display includes a projector capable of projecting images, a combiner able to display the images projected by the projector, and a displacement system for the combiner and the projector. The displacement system is able to rotate the combiner and the projector with respect to a main axis among a plurality of adjustment positions.

This patent application claims the benefit of document FR 16 62170 filed on Dec. 8, 2016 which is hereby incorporated by reference.

### FIELD OF THE INVENTION

The present invention relates to a railway vehicle comprising a driver's cab, wherein the driver's cab comprises a head-up display.

### BACKGROUND OF THE INVENTION

The driving of a vehicle, such as a railway vehicle, is conditioned in large part by the visibility of the driver's surroundings. The surrounding environment comprises, for example, signaling devices, pedestrians, cyclists, or other vehicles. Good visibility allows the driver to make appropriate decisions at the right times and limits the risk of collisions or accidents involving passengers.

For the purposes of driving, the driver is required to consult regularly the dashboard of the vehicle. This implies that for a brief moment, the driver is no longer looking at his surroundings, including the road.

In order to remedy this drawback, head-up displays may be integrated in the dashboard of the vehicle. Such displays make it possible to project information usually displayed on the dashboard in the field of vision of the driver by being superimposed on his external surroundings. The driver no longer needs to take his eyes away, even briefly, from the external environment to consult the dashboard.

However, such displays are not adapted to the morphologies of all types of drivers. The use of such displays by drivers of different morphologies is therefore not optimal.

### SUMMARY OF THE INVENTION

There is therefore a need for a head-up display being suitable for a plurality of drivers of different morphologies.

To this end, the object of the invention is a railway vehicle comprising a driving cab, wherein the driving cab comprises a head-up display, and the head-up display comprises:
a projector able to project images,
a combiner able to display the images projected by the projector, and
a system for moving the combiner and the projector, wherein the displacement system is able to rotate the combiner and the projector with respect to a main axis among a plurality of adjustment positions.

According to other advantageous aspects of the invention, the vehicle comprises one or more of the following characteristics, taken separately or in any technically feasible combination:
the displacement system is able to pivot the combiner relative to the main axis between a retracted position in which the combiner is retracted into a defined internal space in the display, and an extended position in which the combiner is deployed out of the internal space, wherein the deployed position of the combiner corresponds to one of the plurality of adjustment positions;
the displacement system comprises a first actuator and an arm, wherein the arm is secured to the combiner, and wherein the first actuator is designed to rotate the arm about the main axis in order to pivot the combiner about the main axis between the retracted position and the deployed position;
one of the adjustment positions is a reference position, wherein the displacement system is able to rotate the combiner and the projector along the main axis with the same angular difference on either side of the reference position.
the maximum angular difference between the reference position and an adjustment position distinct from the reference position is plus or minus 5 degrees;
the reference position is the position at which the center of the combiner is at the center of the undeformed field of view of a model driver;
the displacement system comprises a second actuator, wherein the second actuator is able to rotate the projector and the combiner about the main axis between the plurality of adjustment positions;
the first actuator and the second actuator are one and the same actuator;
the display comprises a user interface adapted to receiving commands from the driver of the vehicle, wherein the displacement system is actuated according to the command received by the user interface;
the main axis is a transverse axis traversing the projector.

### BRIEF DESCRIPTION OF THE DRAWINGS

Other features and advantages of the invention will become apparent upon reading the following description of embodiments of the invention, only given by way of example, and with reference to the drawings, wherein:

FIG. 1 shows a schematic side view of a driver's cab of a vehicle,

FIG. 2 shows a schematic perspective view of a display according to one embodiment of the invention, wherein the display comprises a combiner,

FIG. 3 shows a schematic partial side view of the display of FIG. 2, wherein the combiner is in a retracted position,

FIG. 4 shows another schematic partial side view of the display of FIG. 2, wherein the combiner is in an extended position, and

FIG. 5 shows a schematic side view of the display of FIG. 3 when the display is positioned in the cab of a vehicle, and wherein the display is movable in a plurality of adjustment positions.

### DETAILED DESCRIPTION OF THE PREFERRED EMBODIMENTS

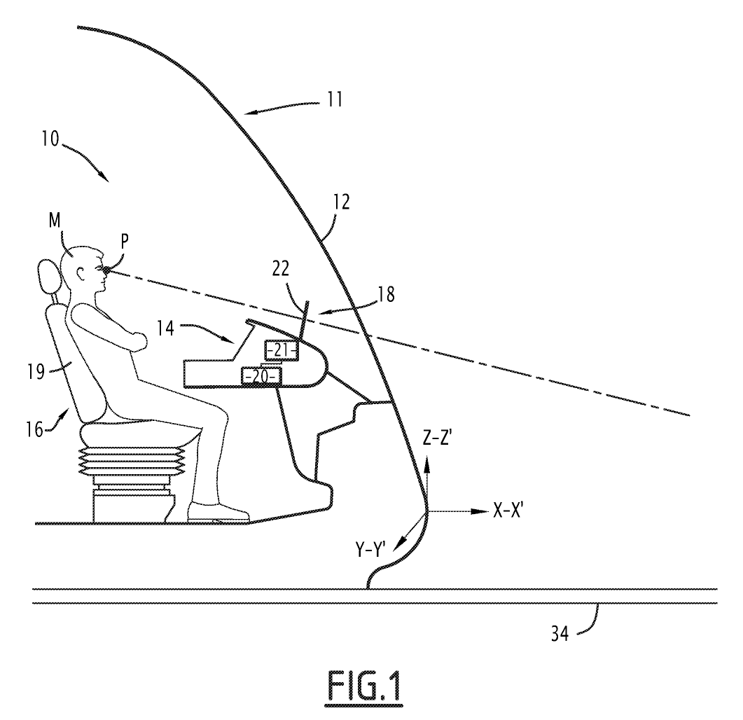

A cab 10 for driving a vehicle 11 is illustrated in FIG. 1.

The vehicle 11 is, for example, a railway vehicle, such as a tram, a train or a tram-train.

In the remainder of the description, the terms “front” and “rear” are defined with respect to the direction of movement of the vehicle 11.

The term “longitudinal” is defined with respect to the direction in which the vehicle 11 travels, i.e. in the case of a railway vehicle, the direction in which the rails on which the vehicle is traveling, extend. The term “transverse” is defined relative to a direction substantially perpendicular to the longitudinal direction in a horizontal plane, i.e. the direction in which the rails are spaced apart from each other. The direction perpendicular to the longitudinal direction and the transverse direction is called the “vertical direction”.

The terms “up” and “down” are defined relative to the vertical direction of the vehicle 11, wherein the “bottom” is relatively closer than the “top” to the rails on which the vehicle 11 is traveling. The terms “upper” and “lower” are understood in a similar way to the terms “high” and “low”, respectively.

The cab 10 extends in the longitudinal direction along a longitudinal axis X-X′, in the transverse direction along a transverse axis Y-Y′, and in the vertical direction along a vertical axis Z-Z′. Such longitudinal X-X′, transverse Y-Y′ and vertical Z-Z′ axes are illustrated in FIG. 1.

The cab 10 comprises a windshield 12, a dashboard 14, a driver location 16 and a head-up display 18.

The driver location 16 includes a seat 19 on which the driver of the vehicle 11 may sit while driving the vehicle 11.

A model driver M is provided comprising, for example, the dimensions of the model driver and the driving posture of the model driver in the cab 10.

The model driver M represents a human template. Such a template is, for example, based on the machine standard NF EN 894-4 version 2010.

The model driver M represents, for example, the fiftieth percentile of the male population, i.e. a man of average size. The size of such a man is 1749 mm according to the machine standard NF EN 894-4 version 2010.

Alternatively, the model driver M represents the fifth percentile of the female population, i.e. a small woman. The size of such a woman is 1560 mm according to the machine standard NF EN 894-4 version 2010.

Alternatively, the model driver M represents the ninety-fifth percentile of the male population, i.e. a tall man. The size of such a man is 1911 mm according to the machine standard NF EN 894-4 version 2010.

The driving posture of the model driver M is defined, for example, by the following elements:
the seat back of the driver location 16 is inclined backwards from 5° to 10° relative to the vertical,
the back of the driver's model is in contact with the seat back,
the seat suspension is of an average value, and
the model driver is able to control the vehicle 11.

The head-up display 18 is positioned in the cab 10. Preferably, the head-up display 18 is positioned in the dashboard 14 of the cab 10.

The head-up display 18 comprises a computer 20, a projector 21 and a combiner 22.

The computer 20 is able to generate images or video sequences. The images generated by the computer 20 relate, for example, to the vehicle speed indicator 11, to the energy consumption of the vehicle 11, to recommendations for the level of traction or braking of the vehicle 11, to alarms relating to the malfunction of certain components of the vehicle 11, to indications on switching changes, indicators on the advance or delay of the vehicle with respect to a predefined time table, maneuvers or coupling to be achieved, or indications on specific locations traversed by the vehicle 11.

The projector 21 is an optical system able to project the images generated by the computer 20 into the field of view of the driver.

The projector 21 is located, along the longitudinal axis X-X′, between the combiner 22 and the driver location 16.

The combiner 22 is usually referred to as a “combiner”.

The combiner 22 is preferably bent at an angle of curvature so that the concave surface of the combiner 22 faces the driver location 16.

In a variant, the combiner 22 is flat.

The dimension of the combiner 22 in the vertical direction Z-Z′, also called “height”, is, for example, greater than or equal to 60 mm. The dimension of the combiner 22 along the transverse axis Y-Y′, also called “length”, is, for example, greater than or equal to 150 mm.

The combiner 22 is, for example, a semi-transparent combiner.

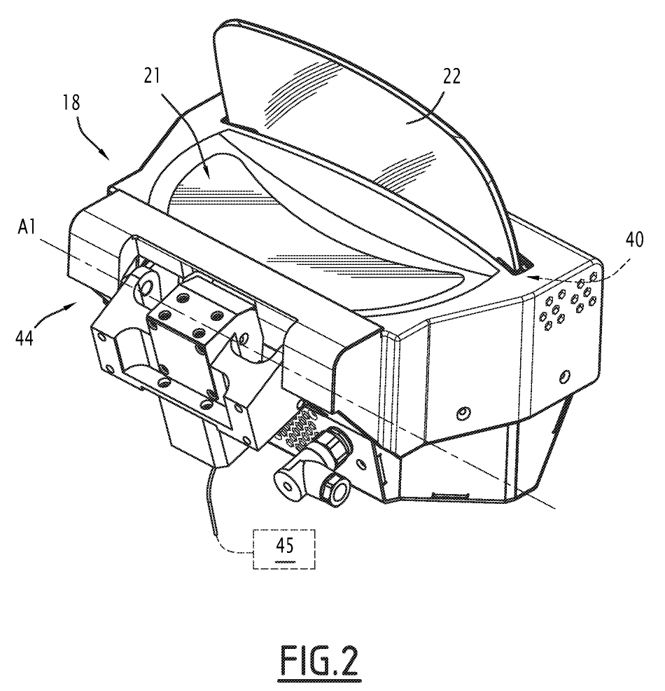

An example of a particular embodiment of a display 18 is illustrated in FIGS. 2 to 5.

The display 18 comprises, in addition to the characteristics listed above, the following characteristics.

The display 18 comprises an internal space 40 for receiving the combiner 22.

In a variant, the internal space 40 is an internal space of the projector 21 of the display 18.

The display 18 further comprises a system 44 for displacing the combiner 22 and a user interface 45.

The displacement system 44 includes a first mechanism 46 and a second mechanism 48.

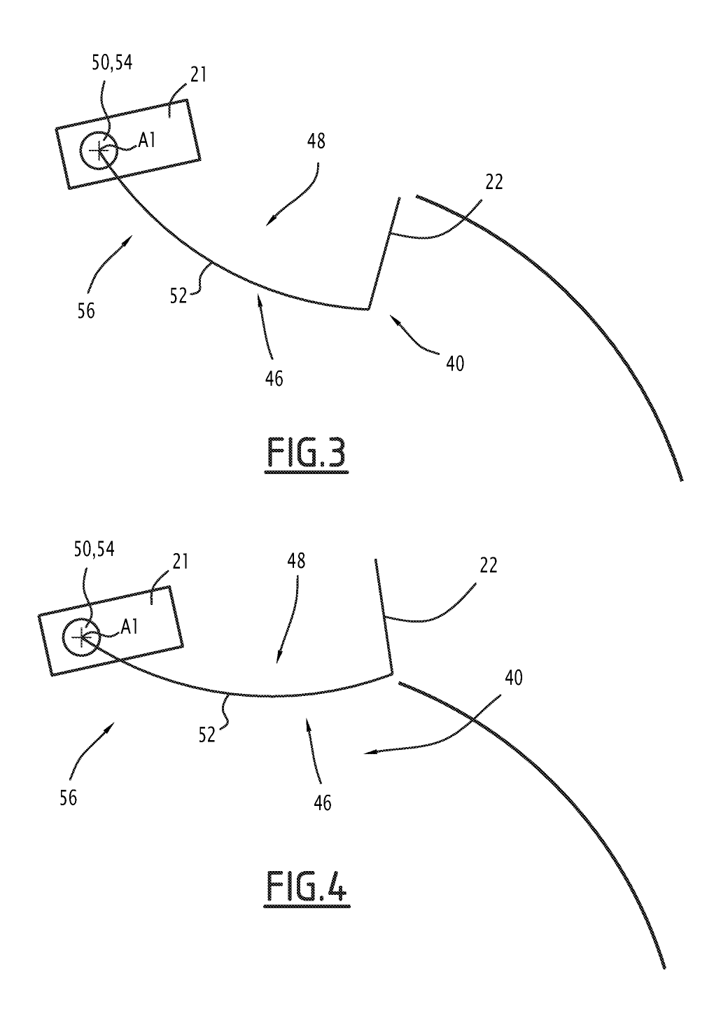

The first mechanism 46 is able to rotate the combiner 22 with respect to a main axis A1 between a retracted position, visible in FIG. 3, in which the combiner 22 is retracted into the internal space 40 of the display 18, and a deployed position, visible in FIG. 4, in which the combiner 22 is deployed outside the projector 21. The retracted position is the position in which the combiner 22 is fully received in the internal space 40 of the display 18. The deployed position is the position in which the combiner 22 is fully positioned outside the internal space 40 of the display 18.

The first mechanism 46 comprises a first actuator 50 and an arm 52 that is integral with the combiner 22.

The first actuator 50 is, for example, an electric motor.

The first actuator 50 is designed to pivot the arm 52 about the main axis Al in order to pivot the combiner 22 about the main axis Al between the retracted position and the deployed position.

The second mechanism 48 comprises a second actuator 54.

The second actuator 54 is, for example, an electric motor.

The second actuator 54 is designed to rotate an assembly 56 about the main axis A1 between a plurality of adjustment positions, for example, via the arm 52. The assembly 56 comprises at least the projector 21 and the combiner 22 of the display 18. In a variant, the assembly 56 comprises the entirety of the display 18.

The second mechanism 48 is, for example, implemented by one or more elements, wherein each element is chosen from the group consisting of: a combined set of connecting rods, a combination of a wheel and a worm gear, cams, a railway system, an assembly comprising at least one chain and at least one pinion, and an assembly comprising at least one pulley and at least one belt.

Alternatively, the second actuator 54 and the first actuator 50 are combined, i.e. the second actuator 54 and the first actuator 50 form a single actuator.

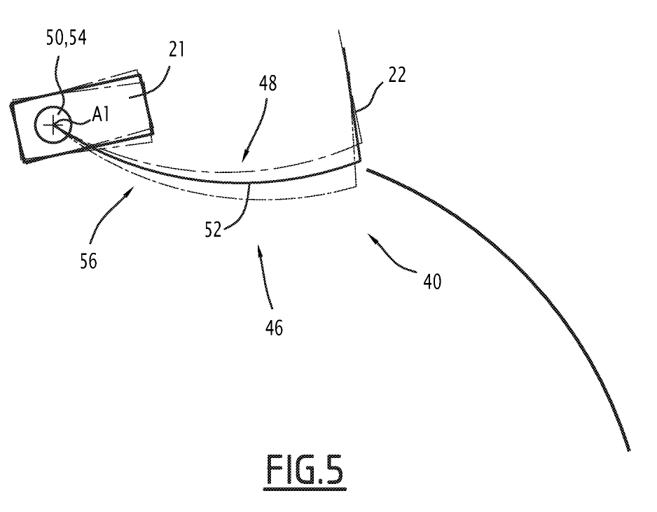

As may be seen in FIG. 5, when the combiner 22 is in the deployed position, the second actuator 54 is able to rotate the assembly 56 about the main axis A1 between a plurality of adjustment positions.

One of the adjustment positions is a reference position. Specifically, the reference position is defined as the adjustment position in which the center of the combiner 22 is located substantially in the center of the undeformed field of view of the model driver M. The undeformed field of view of the model driver M corresponds to the field of view of the model driver M when a spatially-homogeneous deformation is applied to each portion of the images projected by the projector 21 on the plate 22 (in the field of view of the model M driver), compared to the basic images, i.e. the images before the said images are projected by the projector 21 on the combiner 22. Such a deformation is, for example, due to the aberrations introduced by the optics of the projector 21. In such a reference position, the combiner 22 is advantageously located in a plane perpendicular to the direction of view of the model driver in his driving posture.

As may be seen in FIG. 5, the second actuator 54 is able to rotate the assembly 56 comprising at least the projector 21 and the combiner 22 about the main axis A1 with the same angular difference on either side of the reference position.

The maximum angular difference between the reference position and an adjustment position distinct from the reference position is plus or minus 5 degrees in a reference rotation direction. The reference rotation direction is, for example, the clockwise direction. Such angular deviation allows an adjustment of the position of the combiner 22 by the driver.

As a variant, such an angular difference is plus or minus 6 degrees, or even plus or minus 4 degrees.

The main axis A1 is a transverse axis. The main axis A1 traverses, for example, the projector 21. This ensures, in particular, that the projector 21 does not impair the visibility of the driver in the adjustment position despite its movement.

In addition, the joint pivoting of the projector 21 and the combiner 22 makes it possible to maintain a fixed angle between a projection axis of the projector 21 and the combiner 22, wherein the angle is equal to a pre-set angle. Thus, the projected image is not inhomogeneously deformed through an adjustment of the combiner.

The user interface 45 (illustrated in FIG. 2) is able to receive commands from the driver of the vehicle 11. The, or each, actuator 50, 54 is actuated according to the command received by the user interface 45.

The user interface 45 is, for example, a joystick, a control lever or push buttons.

Alternatively, the first actuator 50 is automatically activated when the vehicle 11 starts, in order to move the combiner 22 to the deployed position.

Alternatively or additionally, when the combiner 22 passes from the retracted position to the deployed position, the combiner 22 is automatically positioned in the reference position.

Alternatively, the combiner 22 is automatically positioned according to the last adjustment position controlled by the user interface 45.

Alternatively or additionally, the first actuator 50 is automatically activated when the driver leaves the cab 10 in order to move the combiner 22 to the retracted position.

An example of operation of the display 18 of FIGS. 2 to 5 will now be described.

Initially, the combiner 22 of the display 18 is in the retracted position to protect the combiner 22. The assembly 56 is, for example, positioned in a position where the uppermost end of the combiner 22 according to the vertical axis Z-Z′, is the furthest in the longitudinal direction X-X′ from the driver location 16. Such a position, called the “tall driver” position, is particularly suitable for a tall driver, for example, for the ninety-fifth percentile of the male population.

The driver of the vehicle 11 sends a command via the user interface 45 to move the combiner 22 to the deployed position.

Alternatively, the command may be sent automatically.

The first mechanism 46 then moves the combiner 22 to the deployed position.

The second mechanism 48 moves the assembly 56 to the reference position.

Then, the driver sends a new command via the user interface 45 to move the assembly 56, comprising at least the combiner 22 and the projector 21, to an adjustment position.

The second mechanism 48 then moves the assembly 56 to the selected adjustment position.

The driver thus has an adjusted and not inhomogeneously deformed vision of the projected information.

When the display 18 is no longer used, the driver sends a new command via the user interface 45 to move the combiner 22 to the retracted position.

Alternatively, the command is automatically sent when the driver leaves the cab 10.

The assembly 56 is then placed in the so-called tall driver position, and then the combiner is moved to the retracted position of the said combiner 22.

Thus, the first mechanism 46 of the display 18 illustrated in FIGS. 2 to 5 protects the combiner 22 by returning the combiner 22 into the projector 21, when the combiner 22 is not used.

The second mechanism 48 of the display 18 makes it possible to adjust the setting of the display 18 to meet the needs of a broad range of drivers. In particular, the second mechanism 48 makes it possible to adjust the height of the images projected in the field of view of the driver by adjusting the angular position of the display 18.

In addition, the position of the projector 21 is held fixed relative to the combiner 22, which allows good image quality to be maintained.

Thus, such a display 18 is likely to suit a plurality of drivers of different morphologies.

1. A railway vehicle comprising a driver's cab, wherein the driver's cab comprises a head-up display, the display comprising:
a projector able to project images,
a combiner able to display the images projected by the projector, and
a displacement system for the combiner and the projector, the displacement system being able to rotate the combiner and the projector with respect to a main axis among a plurality of adjustment positions.

2. The vehicle according to claim 1, wherein the displacement system is able to pivot the combiner relative to the main axis between a retracted position in which the combiner is retracted into an internal space defined in the display, and a deployed position in which the combiner is deployed out of the internal space, the deployed position of the combiner corresponding to one of the plurality of adjustment positions.

3. The vehicle according to claim 2, wherein the displacement system comprises a first actuator and an arm, the arm being integral with the combiner, and the first actuator is designed to pivot the arm about the main axis in order to pivot the combiner about the main axis between the retracted position and the deployed position.

4. The vehicle according to claim 1, wherein one of the adjustment positions is a reference position, the displacement system being designed to rotate the combiner and the projector along the main axis with the same angular difference on either side of the reference position.

5. The vehicle according to claim 4, wherein the maximum angular difference between the reference position and an adjustment position distinct from the reference position is plus or minus 5 degrees.

6. The vehicle according to claim 4, wherein the reference position is the position in which the center of the combiner is in the center of the undeformed field of view of a model driver.

7. The vehicle according to claim 1, wherein the displacement system comprises a second actuator, the second actuator being able to rotate the projector and the combiner about the main axis among the plurality of adjustment positions.

8. The vehicle according to claim 3, wherein the first actuator and the second actuator are the same and unique actuator.

9. The vehicle according to claim 1, wherein the display comprises a user interface able to receive commands from the driver of the vehicle, the displacement system being operated according to the command received by the user interface.

10. The vehicle according to claim 1, wherein the main axis is a transverse axis passing through the projector.
